(19) United States
(12) Patent Application Publication
(10) Pub. No.: US 2008/0207830 A1
(43) Pub. Date: Aug. 28, 2008

(54) Thermoplastic Plastic Moulding Compositions with Improved Optical Properties

(75) Inventors: Martin Weber, Maikammer (DE); Axel Gottschalk, Neustadt (DE); Peter Ittemann, Lampertheim (DE); Hans Honl, Obersulzen (DE)

Correspondence Address: CONNOLLY BOVE LODGE & HUTZ LLP, 1875 EYE STREET, N.W., SUITE 1100, WASHINGTON, DC, 20036, US

(73) Assignee: BASF SE, Ludwigshafen (unknown)

(21) Appl. No.: 12/088,759

(22) PCT Filed: Sep. 25, 2006
(86) PCT No.: PCT/EP2006/066664

§ 371 Date: Mar. 31, 2008

(30) Foreign Application Priority Data
Sep. 30, 2005 (DE) 102005047463.2

(51) Int. Cl. C08L 51/00

(52) U.S. Cl. 525/64

(57) ABSTRACT

The present invention relates to thermoplastic molding compositions, comprising a mixture composed of
(A) from 30 to 69% by weight, based on the entirety of components (A), (B) and (C), of a methyl methacrylate polymer,
(B) from 30 to 69% by weight, based on the entirety of components (A), (B) and (C), of a copolymer, obtainable via polymerization of a vinylaromatic monomer and of a vinyl cyanide, and
(C) from 1 to 40% by weight, based on the entirety of components (A), (B) and (C), of a graft copolymer, obtainable from
   (C1) from 60 to 90% by weight, based on (C), of an agglomerated core based on a 1,3-diene,
   (C2) from 5 to 20% by weight, based on (C), of a first graft shell composed of a vinylaromatic monomer, of an alkyl methacrylate, and, if appropriate, of a crosslinking monomer, and
   (C3) from 5 to 20% by weight, based on (C), of a second graft shell composed of an alkyl(meth)acrylate polymer,
      with the proviso that the ratio by weight of (C2) to (C3) is in the range from 2:1 to 1:2,
      and it is inventively significant here that the core (C1) has monomodal particle size distribution, the average particle size D₅₀ of the core (C1) (determined by the method mentioned in the description) is in the range from 300 to 400 nm, and the difference between the refractive index (n_{D}-C) of the entire component (C) and the refractive index (n_{D}-AB) of the entire matrix of components (A) and (B) is in the range from 0.003 to 0.008, each of the refractive indices being measured by the methods mentioned in the description,
      and also to a process for preparation of these molding compositions, to their use, and to the moldings obtainable therefrom.

The present invention relates to thermoplastic molding compositions, comprising a mixture composed of
(A) from 30 to 69% by weight, based on the entirety of components (A), (B) and (C), of a methyl methacrylate polymer, obtainable via polymerization of a mixture, composed of
   (A1) from 90 to 100% by weight, based on (A), of methyl methacrylate, and
   (A2) from 0 to 10% by weight, based on (A), of a C₁-C₈-alkyl ester of acrylic acid, and
(B) from 30 to 69% by weight, based on the entirety of components (A), (B) and (C), of a copolymer, obtainable via polymerization of a mixture, composed of
   (B1) from 75 to 88% by weight, based on (B), of a vinylaromatic monomer, and
   (B2) from 12 to 25% by weight, based on (B), of a vinyl cyanide,
      and
(C) from 1 to 40% by weight, based on the entirety of components (A), (B) and (C), of a graft copolymer, obtainable from
   (C1) from 60 to 90% by weight, based on (C), of a core, obtainable via polymerization of a monomer mixture, composed of
      (C11) from 65 to 89.9% by weight, based on (C1), of a 1,3-diene,
      (C12) from 10 to 34.9% by weight, based on (C1), of a vinylaromatic monomer,
      (C13) from 0.1 to 5% by weight, based on (C1), of an agglomeration polymer,
         and
   (C2) from 5 to 20% by weight, based on (C), of a first graft shell, obtainable via polymerization of a monomer mixture, composed of
      (C21) from 30 to 39% by weight, based on (C2), of a vinylaromatic monomer,
      (C22) from 61 to 70% by weight, based on (C2), of a C₁-C₈-alkyl ester of methacrylic acid, and
      (C23) from 0 to 3% by weight, based on (C2), of a crosslinking monomer,
         and
   (C3) from 5 to 20% by weight, based on (C), of a second graft shell, obtainable via polymerization of a monomer mixture, composed of
      (C31) from 70 to 98% by weight, based on (C3), of a C₁-C₈-alkyl ester of methacrylic acid, and
      (C32) from 2 to 30% by weight, based on (C3), of a C₁-C₈-alkyl ester of acrylic acid,
         and
(D) if appropriate, amounts of up to 20% by weight, based on the entirety of components (A), (B) and (C), of conventional additives
   with the proviso that the ratio by weight of (C2) to (C3) is in the range from 2:1 to 1:2.

The present invention further relates to a process for preparation of the inventive thermoplastic molding compositions, to their use, and to the moldings obtainable therefrom.

WO 97/08241 discloses molding compositions composed of a hard methyl methacrylate polymer, of a hard vinylaromatic-vinyl cyanide polymer, and of a soft graft polymer comprising an elastomeric graft core, a first graft shell composed of a vinylaromatic-alkyl methacrylate polymer, and a second graft shell composed of an alkyl(meth)acrylate polymer. These molding compositions feature good impact resistance, high flowability, high light transmittance, very low haze, and very little yellow tinge at their edges.

A known method of improving the mechanical properties of thermoplastic molding compositions is the use of elastomeric graft copolymers in which the graft core is composed of comparatively large agglomerated particles, which are obtainable during preparation of the graft cores via addition of an agglomeration polymer. These molding compositions based on a very wide variety of plastics matrices are described by way of example in WO 01/83574 and WO 02/10222, as also are processes for their preparation. However, these thermoplastic molding compositions comprising graft cores composed of comparatively large agglomerated particles usually have impaired optical properties.

DE 102004006193.9 (application number) describes thermoplastic molding compositions based on hard methyl methacrylate polymers, on hard vinylaromatic-vinyl cyanide polymers, and on agglomerated graft copolymers with specific particle sizes and with specific distributions of the same, these having not only good mechanical properties but also good optical properties.

An object underlying the present invention was to provide thermoplastic molding compositions based on hard methyl methacrylate polymers, on hard vinylaromatic-vinyl cyanide polymers, and on soft graft copolymers, where these have further-improved optical properties, in particular a low level of light-scattering, while substantially retaining good mechanical properties.

Accordingly, the thermoplastic molding compositions defined at the outset have been found, an important factor for this invention being that the core (C1) has monomodal particle size distribution, the average particle size D₅₀ of the core (C1) (determined by the method mentioned below) is in the range from 300 to 400 nm, and the difference between the refractive index (n_{D}-C) of the entire component (C) and the refractive index (n_{D}-AB) of the entire matrix of components (A) and (B) is in the range from 0.003 to 0.008, each of the refractive indices being measured by the methods mentioned below.

A process for their preparation has also been found, as have their use for production of moldings, and moldings, comprising the inventive thermoplastic molding composition.

The inventive thermoplastic molding compositions, processes, uses, and moldings are described below.

The inventive thermoplastic molding compositions comprise
(A) from 30 to 69% by weight, preferably from 32.5 to 57.5% by weight, based on the entirety of components (A), (B) and (C), of a methyl methacrylate polymer, obtainable via polymerization of a mixture, composed of
   (A1) from 90 to 100%, preferably from 92 to 98% by weight, based on (A), of methyl methacrylate, and
   (A2) from 0 to 10% by weight, preferably from 2 to 8% by weight, based on (A), of a C₁-C₈-alkyl ester of acrylic acid,
(B) from 30 to 69% by weight, preferably from 32.5 to 57.5% by weight, based on the entirety of components (A), (B) and (C), of a copolymer, obtainable via polymerization of a mixture, composed of
   (B1) from 75 to 88% by weight, preferably from 79 to 85% by weight, based on (B), of a vinylaromatic monomer, and
   (B2) from 12 to 25% by weight, preferably from 15 to 21% by weight, based on (B), of a vinyl cyanide,
      and
(C) from 1 to 40% by weight, preferably from 10 to 35% by weight, based on the entirety of components (A), (B) and (C), of a graft copolymer, obtainable from
   (C1) from 60 to 90% by weight, preferably from 70 to 80% by weight, based on (C), of a core with monomodal particle size distribution and with an average particle size D₅₀ (determined by the method described below) in the range from 300 to 400 nm, preferably from 320 to 380 nm, particularly preferably from 340 to 360 nm, obtainable via polymerization of a monomer mixture, composed of
      (C11) from 65 to 89.9% by weight, preferably from 70 to 84.5% by weight, based on (C1), of a 1,3-diene,
      (C12) from 10 to 34.9% by weight, preferably from 15 to 29.5% by weight, based on (C1), of a vinylaromatic monomer, and
      (C13) from 0.1 to 5% by weight, preferably from 0.1 to 2% by weight, based on (C1), of an agglomeration polymer,
         and
   (C2) from 5 to 20% by weight, preferably from 10 to 15% by weight, based on (C), of a first graft shell, obtainable via polymerization of a monomer mixture, composed of
      (C21) from 30 to 39% by weight, preferably from 30 to 35% by weight, particularly preferably from 31 to 35% by weight, based on (C2), of a vinylaromatic monomer,
      (C22) from 61 to 70% by weight, preferably from 63 to 70% by weight, particularly preferably from 63 to 68% by weight, based on (C2), of a C₁-C₈-alkyl ester of methacrylic acid, and
      (C23) from 0 to 3% by weight, preferably from 0 to 2% by weight, particularly preferably from 1 to 2% by weight, based on (C2), of a crosslinking monomer,
         and
   (C3) from 5 to 20% by weight, preferably from 10 to 15% by weight, based on (C), of a second graft shell, obtainable via polymerization of a monomer mixture, composed of
      (C31) from 70 to 98% by weight, preferably from 75 to 92% by weight, based on (C3), of a C₁-C₈-alkyl ester of methacrylic acid, and
      (C32) from 2 to 30% by weight, preferably from 8 to 25% by weight based on (C3), of a C₁-C₈-alkyl ester of acrylic acid,
         and
(D) if appropriate, amounts of up to 20% by weight, preferably from 0 to 10% by weight, based on the entirety of components (A), (B) and (C), of conventional additives.

The methyl methacrylate polymers(A) used in the inventive thermoplastic molding compositions are either homopolymers composed of methyl methacrylate (MMA) or copolymers composed of MMA with up to 10% by weight, based on (A), of a C₁-C₈-alkyl ester of acrylic acid.

The C₁-C₈-alkyl ester of acrylic acid (component A2) used can comprise methyl acrylate, ethyl acrylate, propyl acrylate, n-butyl acrylate, n-pentyl acrylate, n-hexyl acrylate, n-heptyl acrylate, n-octyl acrylate, and 2-ethylhexyl acrylate, or else a mixture thereof, preferably methyl acrylate, ethyl acrylate, n-butyl acrylate, 2-ethylhexyl acrylate, or a mixture thereof, particularly preferably methyl acrylate.

The methyl methacrylate (MMA) polymers can be prepared via bulk, solution, or bead polymerization by known methods (see by way of example Kunststoff-Handbuch [Plastics handbook], volume IX, “Polymethacrylate” [Polymethacrylates], Vieweg/Esser, Carl-Hanser-Verlag 1975) and are available commercially. It is preferable to use methyl methacrylate polymers whose weight-average molar masses M_{w} are in the range from 60 000 to 300 000 g/mol (determined via light scattering in chloroform).

Component (B) is a copolymer composed of a vinylaromatic monomer (B1) and vinyl cyanide (B2).

The vinylaromatic monomer (component B1) used can comprise styrene, or styrene substituted with from one to three C₁-C₈-alkyl radicals, e.g. p-methylstyrene or tert-butylstyrene, or else α-methylstyrene, preferably styrene.

The vinyl cyanide (component B2) used can comprise acrylonitrile and/or methacrylonitrile, preferably acrylonitrile.

Outside the range stated above for the constitution of component (B) the usual result at processing temperatures above 240° C. is cloudy molding compositions which have streaks.

The copolymers (B) can be prepared by known processes, for example via bulk, solution, suspension, or emulsion polymerization, preferably via solution polymerization (see GB-A 14 72 195). Preference is given here to copolymers (B) whose molar masses M_{w} are from 60 000 to 300 000 g/mol, determined via light scattering in dimethylformamide.

The component (C) used comprises a graft copolymer composed of a core (C1) and of two graft shells (C2) and (C3) applied thereto.

The core (C1) is the graft base, and its swelling index SI is from 15 to 50, in particular from 20 to 40, determined via measurement of swelling in toluene at room temperature.

The 1,3-diene (component C11) used in the core of the graft copolymer (component C1) can comprise butadiene and/or isoprene.

The vinylaromatic monomer (component C12) used can comprise styrene or styrene preferably substituted on the ring, preferably in the α-position, with one or more C₁-C₈-alkyl groups, preferably methyl.

The agglomeration polymer (component C13) used can comprise substances known to the person skilled in the art and described by way of example in WO 01/83574, WO 02/10222 or DE-A 24 27 960. Examples of suitable agglomeration polymers are dispersions of acrylate polymers, preferably of copolymers composed of ethyl acrylate and methacrylamide, in which the proportion of methacrylamide is from 0.1 to 20% by weight, based on the copolymer. The concentration of the acrylate polymers in the dispersion is preferably from 3 to 40% by weight, particularly preferably from 5 to 20% by weight.

The core (C1) is prepared in two stages by processes known to the person skilled in the art and described by way of example in Encyclopedia of Polymer Science and Engineering, vol. 1, pp. 407 ff. In the usual method, the first stage uses components (C11) and (C12) in processes known to the person skilled in the art, such as emulsion polymerization (see by way of example Encyclopedia of Polymer Science and Engineering, vol. 1, pp. 401 ff) to prepare a core whose glass transition temperature is preferably below 0° C. and whose average particle size D₅₀ is generally in the range from 30 to 240 nm, preferably in the range from 50 to 180 nm. A second stage involves processes known to the person skilled in the art, and described by way of example in Encyclopedia of Polymer Science and Engineering, vol. 1, pp. 407 ff, for reaction of the core obtained in the first stage with the agglomeration polymer (C13), giving the core (C1) with an average particle size D₅₀ (determined by the method described below) in the range from 300 to 400 nm, preferably from 320 to 380 nm, particularly preferably from 340 to 360 nm. According to the invention, the core (C1) has monomodal particle size distribution.

The graft shell (C2), which comprises the monomers (C21), (C22) and, if appropriate, (C23), is applied to the core (C1).

The vinylaromatic monomer (component C21) used can comprise styrene or styrene preferably substituted on the ring, preferably in the α-position, with one or more C₁-C₈-alkyl groups, preferably methyl.

According to the invention, the C₁-C₈-alkyl ester of methacrylic acid (component C22) used comprises methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methylacrylate, or 2-ethylhexyl methacrylate, particular preference being given to methyl methacrylate, or else comprises a mixture of these monomers.

The monomers (C23) used can comprise conventional crosslinking monomers, i.e. in essence di- or polyfunctional comonomers, in particular alkylene glycol di(meth)acrylates, such as ethylene glycol di(meth)acrylate, propylene glycol di(meth)acrylate and butylene glycol di(meth)acrylate, allyl methacrylate, (meth)acrylates of glycerol, trimethylolpropane, pentaerythritol, or vinylbenzenes, such as di- or trivinylbenzene. It is preferable to use butylene glycol dimethacrylate, butylene glycol diacrylate, and dihydrodicyclopentadienyl acrylate in the form of an isomer mixture, and it is particularly preferable to use dihydrodicyclopentadienyl acrylate in the form of an isomer mixture.

Another graft shell (C3) is in turn grafted onto the graft shell (C2), and comprises the monomers (C31) and (C32). The monomers (C31) are C₁-C₈-alkyl esters of methacrylic acid, and the monomers (C32) are C₁-C₈-alkyl esters of acrylic acid.

According to the invention, the C₁-C₈-alkyl esters of methacrylic acid (monomers C31) used comprise methyl methacrylate (MMA), ethyl methacrylate, n-propyl methacrylate, isopropyl methacrylate, n-butyl methacrylate, isobutyl methacrylate, sec-butyl methacrylate, tert-butyl methacrylate, pentyl methacrylate, hexyl methacrylate, heptyl methacrylate, octyl methylacrylate, or 2-ethylhexyl methacrylate, particular preference being given to methyl methacrylate, or comprise mixtures of these monomers.

The C₁-C₈-alkyl ester of acrylic acid (monomers C32) used can comprise methyl acrylate (MA), ethyl acrylate, propyl acrylate, n-butyl acrylate, isobutyl acrylate, sec.-butyl acrylate, tert-butyl acrylate, pentyl acrylate, hexyl acrylate, heptyl acrylate, octyl acrylate, or 2-ethylhexyl acrylate, methyl acrylate being particularly preferred, or else can comprise a mixture of these monomers with one another.

The two graft shells (C2) and (C3) are prepared in the presence of the core (C1) by methods known from the literature, in particular via emulsion polymerization (Encyclopedia of Polymer Science and Engineering, vol. 1, pp. 401 ff). The “seed procedure” used here forms no new particles during preparation of the two graft shells. Furthermore, the seed procedure permits determination of the number and the nature of the particles in both graft stages via the amount and the nature of the emulsifier used. The emulsion polymerization reaction is usually initiated via polymerization initiators.

The emulsion polymerization reaction can use ionic and non-ionic emulsifiers.

Examples of suitable emulsifiers are sodium dioctyl sulfosuccinate, sodium lauryl sulfate, sodium dodecylbenzenesulfonate, alkylphenoxypolyethylenesulfonates, and salts of long-chain carboxylic and sulfonic acids.

Examples of nonionic emulsifiers are fatty alcohol polyglycol ethers, alkyl aryl polyglycol ethers, fatty acid monoethanolamides, and ethoxylated fatty acid amides and ethoxylated fatty amines.

A total amount of emulsifier, based on the total weight of the emulsion graft copolymer, is preferably from 0.05 to 5% by weight.

Polymerization initiators that can be used are ammonium and alkali metal peroxodisulfates, such as potassium peroxodisulfate, and also combined initiator systems, such as sodium persulfate, sodium hydrogensulfite, potassium persulfate, sodium formaldehyde-sulfoxylate, and sodium peroxodisulfate, sodium dithionite-ferrous sulfate, and the polymerization temperature here for the ammonium and alkali metal peroxodisulfates, which require thermal activation, can be from 50 to 100° C., and for the combined initiator systems acting as redox systems can be lower, for example in the range from 20 to 50° C.

The entire amount of initiator is preferably from 0.02 to 1.0% by weight, based on the finished emulsion polymer.

Both in the preparation of the base, i.e. of the core (C1) and in the preparation of the two graft stages, i.e. of the two graft shells (C2) and (C3), it is also possible to use polymerization regulators. Examples of polymerization regulators are alkyl mercaptans, such as n- or tert-dodecyl mercaptan. The usual amount used of the polymerization regulators is from 0.01 to 1.0% by weight, based on the respective stage.

Other aspects of the preparation method for the emulsion graft copolymer to be used according to the invention are that an aqueous mixture is used as initial charge, composed of monomers, of crosslinking agent, of emulsifier, of initiator, of regulator, and of a buffer system, in a reactor inertized by nitrogen, and the mixture is inertized at low temperature with stirring, and is then brought to the polymerization temperature over the course of from 15 to 120 minutes. The polymerization reaction is then carried out as far as at least 95% conversion. Monomers, crosslinking agent, emulsifier, initiator, and regulator can also be introduced entirely or to some extent in the form of a feed into the aqueous initial charge.

If appropriate, after a continued reaction time of from 15 to 120 minutes, the stages (C2) and (C3) are produced with feed of the monomers in the presence of the previously formed stage (C1) via emulsion polymerization.

Another feature, inter alia, of the inventive thermoplastic molding compositions is that the ratio by weight of the first graft shell (C2) to the second graft shell (C3) is in the range from 2:1 to 1:2.

The emulsion graft polymer is isolated from the resultant latex in a known manner via precipitation, filtration, and then drying. For the precipitation process use may be made, for example, of aqueous solutions of inorganic salts, such as sodium chloride, sodium sulfate, magnesium sulfate, and calcium chloride, or aqueous solutions of salts of formic acid, e.g. magnesium formate, calcium formate, and zinc formate, or aqueous solutions of inorganic acids, such as sulfuric and phosphoric acid, or of aqueous ammoniacal and aminic solutions, or else of other aqueous alkaline solutions, e.g. of sodium hydroxide and of potassium hydroxide. However, physical methods can also be used for the precipitation process, for example freeze precipitation, shear precipitation, steam precipitation.

Examples of drying methods are freeze drying, spray drying, fluidized-bed drying, and drying via air circulation.

Further use of the precipitated emulsion graft copolymer is also possible without drying.

The swelling index (SI) of the graft copolymer (C) is preferably from 10 to 40, in particular from 12 to 35. The swelling index here is determined via measurement of swelling in toluene at room temperature.

Conventional additives (D) that can be used are any of the substances of this type which have good solubility in components (A), (B) and (C), or which have good miscibility with these. Among suitable additives are dyes, stabilizers, lubricants, and antistatic agents.

The inventive molding compositions are prepared from components (A), (B), (C) and, if appropriate, (D) by methods known to the person skilled in the art, for example via mixing of the components in the melt, using apparatus known to the person skilled in the art, at temperatures in the range from 200 to 300° C., in particular from 200 to 280° C.

In one preferred embodiment, a characteristic feature of the inventive thermoplastic molding compositions is that the difference between the refractive index (n_{D}-C) of the entire component (C) and the refractive index (n_{D}-AB) of the entire matrix of components (A) and (B) is in the range from 0.003 to 0.008, in particular in the range from 0.004 to 0.007.

Each of the refractive indices mentioned is to be determined by the methods mentioned below (see examples).

Moldings can be produced from the inventive thermoplastic molding compositions, namely via injection molding or via blow molding. However, the thermoplastic molding compositions can also be pressed, calendered, extruded, or vacuum-formed.

A feature of the inventive thermoplastic molding compositions is that they have further-improved optical properties, in particular a relatively low level of light scattering, while substantially retaining good mechanical properties.

### EXAMPLES

Each of the inventive examples and the comparative examples below prepared thermoplastic molding compositions and determined the following properties:

Refractive Index n_{D} [Dimensionless]:

The reactive indices (n_{D}-C) and (n_{D}-AB) were measured on foils prepressed at 200° C. and at a pressure of from 3 to 5 bar for 2 min and then pressed at 200° C. and 200 bar for 3 min, from the respective polymers (C) or polymer mixtures composed of components (A) and (B), in an IWK press. The measurements were made at 20° C., using an Abbé refractometer by the method for measurement of refractive indices of solids (see Ullmanns Encyklopädie der technischen Chemie [Ullmanns Encyclopedia of industrial chemistry], vol. 2/1, p. 486, editor E. Foerst; Urban & Schwarzenberg, München-Berlin 1961).

Flowability MVI [ml/10 min]:

Melt volume index MVI 220/10 to DIN EN ISO 1133 was determined as a measure of flowability.

Notched Impact Strength aₖ [kJ/m²]:

Notched impact strength aₖ was determined to ISO 179 1eA(F) at 23° C.

### Fracture Energy Ws [Nm]

Fracture energy was determined on plaques of dimensions 60 mm×60 mm×2 mm (length×width×thickness) to ISO 6603.

### Transmittance [%]:

Transmittance was determined to DIN 53236 on plaques of thickness 2 mm.

### Haze [%]:

The haze value to ASTM D1003 was determined on test specimens of thickness 2 mm, as a measure of light scattering.

Average particle size D₅₀:

The average particle size D₅₀ and the particle size distribution of the graft copolymer cores (C1) were determined via evaluation of images from transmission electron micrografts (“TEMs”). Software analysis 3.0 was used here, and the cores (C1) were approximated as circular structures. The particle diameter of at least 500 cores (C1) was determined, and the average value from these determinations is the average particle size D50. The particle size distribution was classified qualitatively as monomodal, bimodal, or polymodal on the basis of the histogram obtained.

### Preparation of Molding Compositions:

A copolymer composed of 95.5% by weight of methyl methacrylate and 4.5% by weight of methyl acrylate with viscosity number VN of 70 ml/g (determined on a 0.5% strength by weight solution in dimethylformamide at 23° C. to DIN 53727) and with refractive index 1.4921 was used as component A.

A copolymer composed of 81% by weight of styrene and 19% by weight of acrylonitrile with viscosity number VN of 62 ml/g (determined on a 0.5% strength by weight solution in dimethylformamide at 23° C. to DIN 53727) and with refractive index 1.5732 was used as component B.

The following rubbers were used as component C:

### C-I:

Graft polymer having 60% by weight (based on graft polymer C-I) of a graft core composed of butadiene and styrene (76% by weight of butadiene and 24% by weight of styrene, based on the weight of the graft core) and 20% by weight (based on graft polymer C-I) of a first graft shell composed of styrene and methyl methacrylate (90% by weight of styrene and 10% by weight of methyl methacrylate, based on the weight of the first graft shell), and 20% by weight (based on graft polymer C-I) of a second graft shell composed of methyl methacrylate and ethyl acrylate (97% by weight of methyl methacrylate and 3% by weight of ethyl acrylate, based on the weight of the second graft shell). The refractive index of the rubber was determined as 1.5371. The average particle size D₅₀ of the rubber core was 365 nm with monomodal particle size distribution.

C-comp.-I (Components Whose Name Includes -comp.- are Non-Inventive and Serve for Comparison):

Graft polymer with 50% by weight (based on graft polymer C-comp.-I) of a graft core composed of butadiene and styrene (76% by weight of butadiene and 24% by weight of styrene, based on the weight of the graft core), and 30% by weight (based on graft polymer C-comp.-I) of a first graft shell composed of styrene (100% by weight of styrene, based on the weight of the first graft shell), and 20% by weight (based on graft polymer C-comp.-I) of a second graft shell composed of methyl methacrylate and ethyl acrylate (98% by weight of methyl methacrylate and 2% by weight of ethyl acrylate, based on the weight of the second graft shell). The refractive index of the rubber was determined as 1.540. The average particle size of the rubber core was 45 nm with monomodal particle size distribution.

C-comp.-II (Components Whose Name Includes -comp.- are Non-Inventive and Serve for Comparison):

Graft polymer with 50% by weight (based on graft polymer C-comp.-II) of a graft core composed of butadiene and styrene (76% by weight of butadiene and 24% by weight of styrene, based on the weight of the graft core), and 30% by weight (based on graft polymer C-comp.-II) of a first graft shell composed of styrene (100% by weight of styrene, based on the weight of the first graft shell), and 20% by weight (based on graft polymer C-comp.-II) of a second graft shell composed of methyl methacrylate and ethyl acrylate (98% by weight of methyl methacrylate and 2% by weight of ethyl acrylate, based on the weight of the second graft shell). The refractive index of the rubber was determined as 1.540. The average particle size of the rubber core was 155 nm with monomodal particle size distribution.

The parts by weight of components A, B, and C stated in table 1 were used in a melt at temperatures of 250° C. to prepare the molding compositions given in table 1. Unless otherwise stated, processing to give test specimens took place at a melt temperature of 250° C. and at a mold temperature of 60° C. The standard specimens for notched impact strength tests were also produced at a melt temperature of 230° C. and 270° C.

TABLE 1

| | | Example No. | | | | | | |
|---|---|---|---|---|---|---|---|---|
| | | comp. 1 | comp. 2 | comp. 3 | comp. 4 | 5 | 6 | comp. 7 |
| Components*: | | | | | | | | |
| A | | 27 | 31 | 27 | 30.45 | 35.56 | 36.54 | 38.5 |
| B | | 37 | 33 | 37 | 39.55 | 34.44 | 33.46 | 31.5 |
| C-I | | — | — | — | 30 | 30.0 | 30.0 | 30.0 |
| C-comp.-I | | 5.4 | 5.4 | — | — | — | — | — |
| C-comp.-II | | 30.6 | 30.6 | 36 | — | — | — | — |
| D₅₀ [nm] | | bi | bi | 155 | 365 | 365 | 365 | 365 |
| PSD** | | bi | bi | mono | mono | mono | mono | mono |
| Δn*** | | 0.001 | 0.0061 | 0.0014 | 0.001 | 0.005 | 0.007 | 0.0085 |
| Properties: | | | | | | | | |
| MVI [ml/10′] | | 12 | 14.5 | 16.2 | 16.9 | 17.1 | 16.6 | 17.3 |
| ak | 23° C. [kJ/m²] | 6.3 | 5.8 | 5.8 | 12.5 | 12.8 | 12.7 | 12.4 |
| | 250° C. [kJ/m²] | 10.8 | 9.1 | 9.5 | 12.9 | 13.1 | 13.3 | 12.9 |
| | 270° C. [kJ/m²] | 11.0 | 9.3 | 9.4 | 13.2 | 13.4 | 13.1 | 13.2 |

| | | | | | | | |
|---|---|---|---|---|---|---|---|
| Ws [Nm] | 12.7 | 14.7 | 15.2 | 16.1 | 15.8 | 17.0 | 16.2 |
| T [%] | 88.5 | 85.7 | 86.3 | 84.9 | 89.5 | 88.6 | 87.2 |
| Haze [%] | 4.7 | 10.1 | 5.7 | 11.3 | 3.7 | 5.1 | 9.2 |

*components or examples whose name includes-comp.- are non-inventive and serve for comparison
**particle size distribution: mono = monomodal, bi = bimodal
***numerical difference between refractive index (n_{D} − C) of entire component (C) and refractive index (n_{D} − AB) of the entire matrix of components (A) and (B)

The examples confirm that the inventive molding compositions have very good toughness and flowability, and optical properties (high transparency, low haze). In contrast, the comparative examples using smaller-dimension rubbers show the known behavior, i.e. low haze for Δn close to 0. Surprisingly, the inventive molding compositions moreover show no dependency of notched impact strength on processing conditions.

1. A thermoplastic molding composition, comprising a mixture composed of
(A) from 30 to 69% by weight, based on the entirety of components (A), (B) and (C), of a methyl methacrylate polymer, obtainable via polymerization of a mixture, composed of
(A1) from 90 to 100% by weight, based on (A), of methyl methacrylate, and
(A2) from 0 to 10% by weight, based on (A), of a C₁-C₈-alkyl ester of acrylic acid, and
(B) from 30 to 69% by weight, based on the entirety of components (A), (B) and (C), of a copolymer, obtainable via polymerization of a mixture, composed of
(B1) from 75 to 88% by weight, based on (B), of a vinylaromatic monomer, and
(B2) from 12 to 25% by weight, based on (B), of a vinyl cyanide,
and
(C) from 1 to 40% by weight, based on the entirety of components (A), (B) and (C), of a graft copolymer, obtainable from
(C1) from 60 to 90% by weight, based on (C), of a core, obtainable via polymerization of a monomer mixture, composed of
(C11) from 65 to 89.9% by weight, based on (C1), of a 1,3-diene,
(C12) from 10 to 34.9% by weight, based on (C1), of a vinylaromatic monomer,
(C13) from 0.1 to 5% by weight, based on (C1), of an agglomeration polymer,
and
(C2) from 5 to 20% by weight, based on (C), of a first graft shell, obtainable via polymerization of a monomer mixture, composed of
(C21) from 30 to 39% by weight, based on(C2), of a vinylaromatic monomer,
(C22) from 61 to 70% by weight, based on (C2), of a C₁-C₈-alkyl ester of methacrylic acid, and
(C23) from 0 to 3% by weight, based on (C2), of a crosslinking monomer,
and
(C3) from 5 to 20% by weight, based on (C), of a second graft shell, obtainable via polymerization of a monomer mixture, composed of
(C31) from 70 to 98% by weight, based on (C3), of a C₁-C₈-alkyl ester of methacrylic acid, and
(C32) from 2 to 30% by weight, based on (C3), of a C₁-C₈-alkyl ester of acrylic acid,
and
(D) if appropriate, amounts of up to 20% by weight, based on the entirety of components (A), (B) and (C), of conventional additives
with the proviso that the ratio by weight of (C2) to (C3) is in the range from 2:1 to 1:2, wherein
the core (C1) has monomodal particle size distribution,
the average particle size D₅₀ of the core (C1) (determined by the method mentioned in the description) is in the range from 300 to 400 nm, and
the difference between the refractive index (n_{D}-C) of the entire component (C) and the refractive index (n_{D}-AB) of the entire matrix of components (A) and (B) is in the range from 0.003 to 0.008, each of the refractive indices being measured by the methods mentioned in the description.

2. The thermoplastic molding composition according to claim 1, wherein the average particle size D₅₀ of the core (C1) (determined by the method mentioned in the description) is in the range from 320 to 380 nm.

3. The thermoplastic molding composition according to claim 1, wherein the difference between the refractive index (n_{D}-C) of the entire component (C) and the refractive index (n_{D}-AB) of the entire matrix of components (A) and (B) is in the range from 0.004 to 0.007, each of the refractive indices being measured by the methods mentioned in the description.

4. The thermoplastic molding composition according to claim 1, wherein monomeric styrene is used as vinylaromatic monomer.

5. The thermoplastic molding composition according to claim 1, where the swelling index SI of the graft copolymer (C) is from 10 to 40, the swelling index SI being determined by the methods mentioned in the description.

6. A process for preparation of the thermoplastic molding compositions according to claim 1, which comprises mixing components (A), (B), (C), and, if appropriate, (D) in the melt.

7. The method of producing moldings comprising preparing the thermoplastic molding compositions according to claim 1.

8. A molding, comprising thermoplastic molding compositions according to claim 1.

9. The thermoplastic molding composition according to claim 2, wherein the difference between the refractive index (n_{D}-C) of the entire component (C) and the refractive index (n_{D}-AB) of the entire matrix of components (A) and (B) is in the range from 0.004 to 0.007, each of the refractive indices being measured by the methods mentioned in the description.

10. The thermoplastic molding composition according to claim 2, wherein monomeric styrene is used as vinylaromatic monomer.

11. The thermoplastic molding composition according to claim 3, wherein monomeric styrene is used as vinylaromatic monomer.

12. The thermoplastic molding composition according to claim 2, where the swelling index SI of the graft copolymer (C) is from 10 to 40, the swelling index SI being determined by the methods mentioned in the description.

13. The thermoplastic molding composition according to claim 3, where the swelling index SI of the graft copolymer (C) is from 10 to 40, the swelling index SI being determined by the methods mentioned in the description.

14. The thermoplastic molding composition according to claim 4, where the swelling index SI of the graft copolymer (C) is from 10 to 40, the swelling index SI being determined by the methods mentioned in the description.

15. A process for preparation of the thermoplastic molding compositions according to claim 2, which comprises mixing components (A), (B), (C), and, if appropriate, (D) in the melt.

16. A process for preparation of the thermoplastic molding compositions according to claim 3, which comprises mixing components (A), (B), (C), and, if appropriate, (D) in the melt.

17. A process for preparation of the thermoplastic molding compositions according to claim 4, which comprises mixing components (A), (B), (C), and, if appropriate, (D) in the melt.

18. A process for preparation of the thermoplastic molding compositions according to claim 5, which comprises mixing components (A), (B), (C), and, if appropriate, (D) in the melt.

19. The method of producing moldings comprising preparing the thermoplastic molding compositions according to claim 2.

20. The method of producing moldings comprising preparing the thermoplastic molding compositions according to claim 3.
